(19) United States
(12) Patent Application Publication
(10) Pub. No.: US 2015/0012461 A1
(43) Pub. Date: Jan. 8, 2015

(54) SYSTEM FOR HANDLING INVESTMENT PROCESS AT LOWER RISK ENTITIES

(71) Applicant: CENTRUM ROZWOJU KAPITALU SPOLKA Z O.O., Bydgoszcz (PL)

(72) Inventors: Joanna WOZNIAK, Swiecie (PL); Arkadiusz Jaroslaw KILANOWSKI, Bydgoszcz (PL); Tomasz SCHMIDT, Bydgoszcz (PL)

(73) Assignee: CENTRUM ROZWOJU KAPITALU SPOLKA Z O.O., Bydgoszcz (PL)

(21) Appl. No.: 14/295,560

(22) Filed: Jun. 4, 2014

(30) Foreign Application Priority Data
Jul. 3, 2013 (PL) PL-404509

(51) Int. Cl. G06Q 40/06

(52) U.S. Cl. CPC G06Q 40/06
USPC 705/36 R

(57) ABSTRACT

The subject matter of the invention is a system for handling investment process at lower risk entities, concerning information processing in financial investments, communication and processing of information with the aim to optimise investment methods. The system consists of the main server (1), used for processing and archiving information and for handling the flow of information between the elements of system software (2), data processing units of “investor unit” type (IU) (3), which comprises of PCs, working on the basis of the operating system, connected with the system's network and mobile telephony devices (4) as well as data processing units of “bidder unit” type (BU) (5), which comprises of PCs, working on the basis of the operating system, connected with the system's network and mobile telephony devices (4). All data processing units interact with each other in each of the processes only via the main server (1).

### FIELD OF THE INVENTION

The subject matter of the invention is a system for handling investment process in lowest risk entities, concerning processing of information in financial investment, communication and processing of information, with the aim to optimize investment methods.

### BACKGROUND OF THE INVENTION

In already known methods and systems for handling investment process and processing of information in financial investment process, communication and information processing is performed traditionally by comparing offers physically.

Current disclosed state of art as well as the related solutions available on the market do not provide integrated systems and methods for handling and processing of information in a financial investment process.

### SUMMARY

The essence of the solution is a system composed of closed ICT network cooperating and connected with electronic devices such as computers, main server, mobile telephony devices, as well as software dedicated to the data processing system. The system provides communication and information processing method which simplifies and optimizes investment process.

The system for handling investment process according to the invention consists of the main server used for processing and archiving information as well as for handling the flow of information between other elements of the system, software intended for handling the operations of system's units, data processing units of “investor unit” (IU) type, which consist of the devices such as PCs, working on the basis of the operating system, connected with the system's network as well as mobile telephony devices. The system is also made of the data processing units of “bidder unit” type (BU), which comprises of PCs, working on the basis of the operating system, connected with the system's network as well as mobile telephony devices (GSM). The operator data processing unit (OU) is the element of the whole system with all data processing units interacting with each other in all processes only via the main server.

The advantage of the system according to the invention is, by direct combination of “investor” and “bidder” type units, the possibility of depositing funds with the highest at a given time interest rate without performing time-consuming comparison of bank offers. An automatic profit calculation system handled by the main server throughout the bidding time and at the moment of depositary selection allows one to compare and select the most beneficial bids in real time.

The advantage of the system according to the invention is also the possibility of getting the best at a given time offer available on the market, designed for individual deposit, i.e. adapted both to the amount available to the investor and the period of depositing funds, while ensuring due security required for banking system based solutions.

### BRIEF DESCRIPTION OF THE DRAWING

The subject matter of the invention is shown in the embodiment in accompanying drawing of a block diagram of the system.

### DETAILED DESCRIPTION

### Example 1

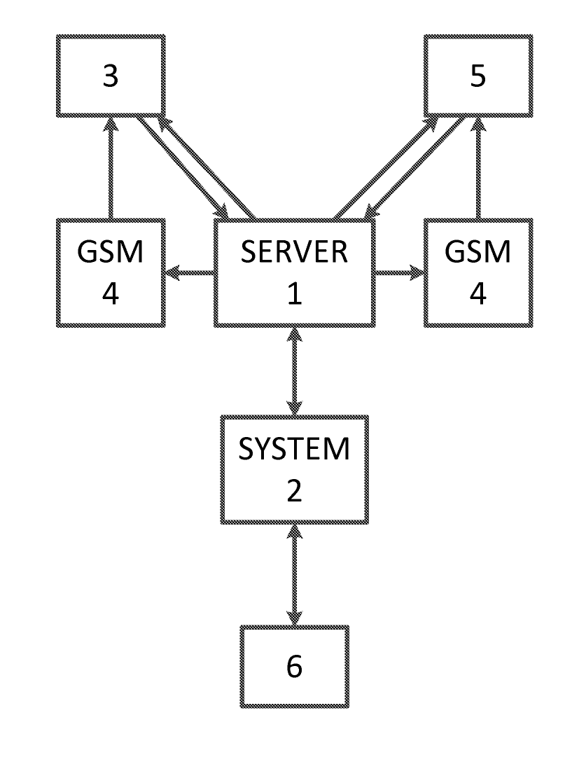

System for handling investment process at lower risk entities, concerning information processing in financial investment process shown in FIG. 1 consists of the main server 1, used for processing and archiving information and for handling the flow of information between other components of the system, software 2 intended for the system operations, data processing units of “investor unit” type (IU) 3, which comprises of PCs, working on the basis of the operating system, connected with the system's network, mobile telephony devices 4 as well as data processing units of “bidder unit” type (BU) 5, which comprises of PCs, working on the basis of the operating system, connected with the system's network as well as mobile telephony devices 4. The operator data processing unit (OU) 6 is the element of the whole system. All data processing units interact with each other in each of the processes only via the main server 1.

The system operation according to the invention consists in that in a first stage, customer using a computer and an internet browser, creates an account on the system's website by entering the system required data, both the investor and the bidder, on a special application forms. Subsequently, filled out forms are sent via the system the server for further processing. Next, the customer selects a specific group resulting in granting further authorizations in the system, in the case an investor (IU) category is selected, further authorization enable launching an auction and in the case of bidders (BU) authorization enable active participation in an auction—bidding.

The system's main server, based on data received, generates a specimen agreement and transfers it to an operator unit (OU) where it is signed with a qualified electronic signature and then entered in the server's database. An agreement signed by the operator is sent electronically from the server's database to customer. Then customer signs the agreement with a qualified electronic signature and send it back via an electronic mail to the server's system.

Optionally, the agreement is printed off and sent to the operator and then scanned and registered with the application database on the server. After receipt and acceptance of the agreement, the operator activates an account and information on activation is automatically sent via the server to customer.

When entering the system, customer—investor (IU) defines process parameters, providing in particular deposit amount and term, minimum expected interest rate, duration of an auction, etc. and then send notification to the server. Next, the server, using a dedicated program, generates defined parameters in a tabular form and sends them back to the investor unit, in order to receive confirmation—acceptance of parameters.

After confirmation is received from the customer's unit (IU) and after data are accepted, the server generates and then sends a unique code in a text message to a customer's mobile phone. Information on deposit handling is published on the platform in accordance with parameters indicated by investor.

After receipt of information on bid from bidder unit (BU), the server generates and sends a unique code to a customer's (IU) mobile telephone as a text message. Then, the server publishes bidder's offer on the system's internet website and perform analysis of the same and then develops graphically current information on the course of an auction.

Duration of an auction is defined by investor. After expiry of preset time, the server automatically performs analysis of information, publishes it graphically and then sends the information on an auction's end to investor (IU) and the winning bidder (BU).

### Example 2

System for handling investment process at lower risk entities, concerning information processing in financial investment process shown in FIG. 1, consists of the elements described in Example 1.

The system according to the invention operates as an auction website, where customers, investors and banks establish contacts by defining an auction and participation in bidding. Client (IU) enters bid parameters in the system's main server, then the main server processes entered data and accordingly distributes the data to “bank” type clients' computers (BU). “Bank” type clients (BU) enter proposed interest rate. The main server processes the information and generates a list of bank deposit products indicating the best offer at a given time. Operations are performed until the end of an auction. Then the server stops receiving information from banks' computers. Clients of type (BU) can view other offers and make multiple offers during an effective period of deposit agreement.

At this stage, access to the main server and auction data is limited to viewing only for (IU) type client. After an auction ends, the main server processes gathered information and generates a report providing (IU) type clients and (BU) type banks with the most advantageous offer.

Putting up funds for auction requires that the additional auction subject conditions as well as participants be defined in accordance with website conditions, including determination whether or not an auction will be publicly available (open) or directed to specific entity (closed), as well as indication of invited bidders, confirmation of the intention to open an auction on the website by filling out/unchecking appropriate part/option of a form/account confirmation of the auction opening by entering a personal code received in a text message. After an auction has been confirmed as open, investor (IU) cannot independently change information and parameters or cancel an auction. Only accounts users with bidder status (BU) are authorized to take part in bidding. Bidders receive information about open auction on the website or by receiving invitation in the case of closed auction. Bidders commence bidding by making offers through filling out/unchecking the appropriate part/option of a form/account and confirming their participation by entering a personal code received in a text message.

Bidders take part in an auction by offering a rate of interest that is higher than the last offer for specific funds put up for auction by investors. Bidders confirm their offer by entering a personal code received in a text message. Upon making an offer, bidders give consent for provision of the relevant information to investors—identification data contained in their accounts.

An auction will be deemed to end ineffectively if there are no offers meeting investors' criteria made before expiry of the term, defined by investors, for putting funds for auction or in the case of interruption for other reasons beyond the operator's control.

An auction will be deemed to end effectively in the case at least one offer is made which satisfies criteria defined by an investor, before expiry of the term, defined by investors, for putting funds for auction. The winner of an auction is a bidder who offered the highest interest rate for funds to be deposited. If several bidders made offers with the same highest rate of interest, the winner is the bidder who was the first to make the highest interest rate offer. An auction ends upon expiry of its duration.

Successful closure of an auction imposes an obligation on an investor to provide funds to the winning bidder under conditions defined in the auction terms and conditions and to provide the winning bidder with relevant documents and perform actions necessary to enter into a deposit service agreement.

1. A system for handling investment process at lower risk entities characterised in that it comprises:
a main server (1) for processing and archiving data and for handling the flow of information between the system's computer software components (2), intended for handling the system operations; as well as
data processing units of investor unit type (IU) (3), which comprises of PCs working on the bases of the operating system, connected with the system's network and mobile communication devices (4) as well as data processing unit of bidder unite type (BU) (5) which consists of PCs working on the bases of the operating system, connected with the system's network and mobile communication devices (4), furthermore an element of the whole system is the data processing unit of the operator (OU) (6).

2. The system according to claim 1, wherein the system units are connected with each other via the main server (1).

3. The system according to the claim 1, wherein the investor unit (IU) enter bid parameters in the system's main server (1) and then the server sends the data to bidder units (BU) (5), who enter proposed interest rate and then the data are transferred to the main server (1) which analyzes and generates a list of bids, indicating the best bid;
wherein operations are performed until the end of an auction after which the server blocks the information transmission from bidder units' computers (BU) (5);
then an access for bidder unit (BU) (5) to the main server and auction data is limited only to viewing; and
after the end of an auction, the main server processes information and generates a report for both an investor (IU) (3) and a bidder (BU) (5) units.

4. The system according to the claim 1 wherein the clients of bidder units computers (BU) (5) have a possibility of viewing the bids and placing multiple offers in the effective term of a deposit.

5. The system according to claim 1, wherein an auction is extended by a subsequent 5 minutes if a bid is made in the last minute of an auction.
